(19) United States
(12) Patent Application Publication
(10) Pub. No.: US 2024/0153693 A1
(43) Pub. Date: May 9, 2024

(54) INDUCTOR COMPONENT

(71) Applicant: Murata Manufacturing Co., Ltd., Kyoto-fu (JP)

(72) Inventors: Yuuki KAWAKAMI, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 18/503,886

(22) Filed: Nov. 7, 2023

(30) Foreign Application Priority Data
Nov. 8, 2022 (JP) 2022-178845

(51) Int. Cl. H01F 27/28; H01F 17/00; H01F 27/02; H01F 27/32

(52) U.S. Cl. CPC H01F 27/2823; H01F 17/0006; H01F 27/022; H01F 27/323; H01F 2017/0066

(57) ABSTRACT

An inductor component capable of improving an inductance value includes an element body that includes a magnetic layer and has a first principal surface and a second principal surface opposite to each other; a coil in the element body; and an insulation layer that covers a part of an outer surface of the coil. The coil has a first inductor wire wound along a plane orthogonal to a first direction which is orthogonal to the first principal surface and is from the second principal surface toward the first principal surface. At least a part of an inner peripheral surface of an innermost periphery of the first inductor wire is in contact with the magnetic layer without being covered with the insulation layer.

### CROSS-REFERENCE TO RELATED APPLICATION

This application claims benefit of priority to Japanese Patent Application No. 2022-178845, filed Nov. 8, 2022, the entire content of which is incorporated herein by reference.

### BACKGROUND

### Technical Field

The present disclosure relates to an inductor component.

### Background Art

Conventionally, as an inductor component, there is an inductor component described in Japanese Patent Application Laid-Open No. 2020-136467. The inductor component includes an element body including a magnetic layer, a coil disposed in the element body, and an insulation layer covering the entire outer surface of the coil.

### SUMMARY

However, in the conventional inductor component, the insulation layer covers the entire outer surface of the coil, and thus, the volume of the magnetic layer cannot be ensured, and a desired inductance value may fail to be obtained.

Therefore, the present disclosure provides an inductor component capable of improving an inductance value.

An inductor component according to one aspect of the present disclosure includes an element body that includes a magnetic layer and has a first principal surface and a second principal surface opposite to each other; a coil that is disposed in the element body; and an insulation layer that covers a part of an outer surface of the coil. The coil has a first inductor wire wound along a plane orthogonal to a first direction which is orthogonal to the first principal surface and is from the second principal surface toward the first principal surface. At least a part of an inner peripheral surface of an innermost periphery of the first inductor wire being in contact with the magnetic layer without being covered with the insulation layer.

According to the above-described aspect, at least a part of the inner peripheral surface of the innermost periphery of the first inductor wire is in contact with the magnetic layer without being covered with the insulation layer, and thus, the volume of the magnetic layer can be increased as compared with the case where the entire outer surface of the first inductor wire is covered with the insulation layer. As a result, the inductance value of the inductor component can be improved.

According to the inductor component according to one aspect of the present disclosure, the inductance value can be improved.

### BRIEF DESCRIPTION OF THE DRAWINGS

FIG. 1 is a schematic plan view illustrating a first embodiment of an inductor component;

FIG. 2 is a sectional view taken along II-II of FIG. 1;

FIG. 3 is a schematic sectional view illustrating a modification of the inductor component;

FIG. 4A is an explanatory diagram illustrating a manufacturing method of the inductor component;

FIG. 4B is an explanatory diagram illustrating the manufacturing method of the inductor component;

FIG. 4C is an explanatory diagram illustrating the manufacturing method of the inductor component;

FIG. 4D is an explanatory diagram illustrating the manufacturing method of the inductor component;

FIG. 4E is an explanatory diagram illustrating the manufacturing method of the inductor component;

FIG. 4F is an explanatory diagram illustrating the manufacturing method of the inductor component;

FIG. 4G is an explanatory diagram illustrating the manufacturing method of the inductor component;

FIG. 4H is an explanatory diagram illustrating the manufacturing method of the inductor component;

FIG. 4I is an explanatory diagram illustrating the manufacturing method of the inductor component;

FIG. 5 is a schematic plan view illustrating a second embodiment of the inductor component;

FIG. 6 is a sectional view taken along VI-VI of FIG. 5; and

FIG. 7 is a schematic sectional view illustrating a third embodiment of the inductor component.

### DETAILED DESCRIPTION

Hereinafter, an inductor component which is one aspect of the present disclosure will be described in detail with reference to illustrated embodiments. Note that the drawings include some schematic drawings, and may not reflect actual dimensions and ratios.

### First Embodiment

(Configuration)

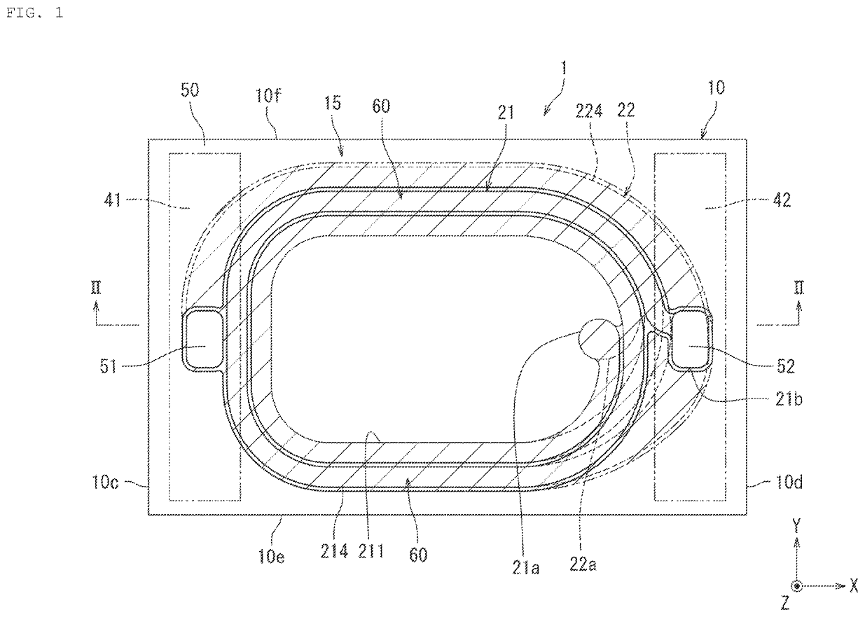

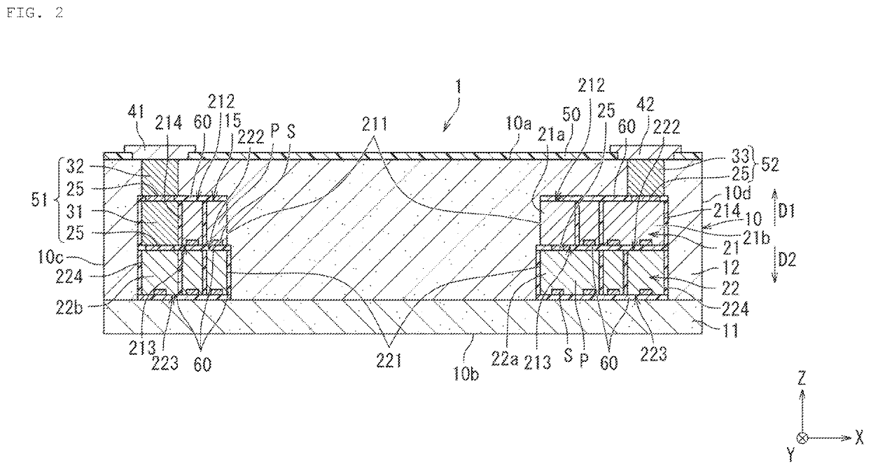

FIG. 1 is a schematic plan view illustrating a first embodiment of an inductor component. FIG. 2 is a sectional view taken along II-II of FIG. 1. In FIG. 1, for convenience, the positions where an insulation layer is present are shaded.

For example, an inductor component 1 is mounted on an electronic device such as a personal computer, a DVD player, a digital camera, a TV, a mobile phone, or car electronics, and has a rectangular shape as a whole. However, the shape of the inductor component 1 is not particularly limited, and may be a columnar shape, a polygonal columnar shape, a truncated cone shape, or a polygonal frustum shape.

As illustrated in FIG. 1 and FIG. 2, the inductor component 1 includes an element body 10, a coil 15 disposed in the element body 10, an insulation layer 60 covering a part of an outer surface of the coil 15, a first extended wire 51 and a second extended wire 52 provided in the element body 10 in a manner that an end surface is exposed from a first principal surface 10a of the element body 10, a first external electrode 41 and a second external electrode 42 exposed on the first principal surface 10a of the element body 10, and a covering layer 50 provided on the first principal surface 10a of the element body 10.

The shape of the element body 10 is not particularly limited, and is a rectangular parallelepiped shape according to this embodiment. The outer surface of the element body 10 includes the first principal surface 10a and a second principal surface 10b, and a first side surface 10c, a second side surface 10d, a third side surface 10e, and a fourth side surface 10f that are located between the first principal surface 10a and the second principal surface 10b and connect the first principal surface 10a and the second principal surface 10b. The first principal surface 10a and the second principal surface 10b face each other. The first side surface 10c and the second side surface 10d face each other. The third side surface 10e and the fourth side surface 10f face each other.

In the drawing, a thickness-wise direction (in other words, a direction orthogonal to the first principal surface 10a) of the element body 10 is defined as a Z direction, a direction from the second principal surface 10b toward the first principal surface 10a is defined as a forward Z direction, and the direction opposite to the forward Z direction is defined as a reverse Z direction. In this description, the forward Z direction is defined as the upper side and the reverse Z direction is defined as the lower side. In a plane orthogonal to the Z direction of the element body 10, a length direction that is a longitudinal direction of the element body 10 and is a direction in which the first external electrode 41 and the second external electrode 42 are arranged is defined as an X direction, and a width direction of the element body 10 that is a direction orthogonal to the length direction is defined as a Y direction. In the X direction, the direction from the first side surface 10c toward the second side surface 10d is defined as a forward X direction, and the direction opposite to the forward X direction is defined as a reverse X direction. In the Y direction, the direction from the third side surface 10e toward the fourth side surface 10f is defined as a forward Y direction, and the direction opposite to the forward Y direction is defined as a reverse Y direction. The forward Z direction corresponds to a “first direction” recited in the claims. The reverse Z direction corresponds to a “second direction” recited in the claims. In the drawing, the first direction is indicated by a reference sign D1 and the second direction is indicated by a reference sign D2.

The element body 10 includes a first magnetic layer 11 and a second magnetic layer 12 sequentially disposed in the first direction D1. Here “sequentially” merely indicates the positional relation between the first magnetic layer 11 and the second magnetic layer 12, and is irrelevant to the sequence of forming the first magnetic layer 11 and the second magnetic layer 12.

Each of the first magnetic layer 11 and the second magnetic layer 12 contains a magnetic powder and a resin containing the magnetic powder. The resin is, for example, an organic insulating material including an epoxy-based resin, a phenol-based resin, a liquid crystal polymer-based resin, a polyimide-based resin, an acrylic resin, or a mixture containing them. The magnetic powder is, for example, an FeSi-based alloy such as FeSiCr, an FeCo-based alloy, an Fe-based alloy such as NiFe, or an amorphous alloy thereof. Therefore, as compared with a magnetic layer made of ferrite, the DC superposition characteristics can be improved by the magnetic powder, and the magnetic powder is insulated from each other by the resin, and thus, the loss (iron loss) at high frequency is reduced. Note that the magnetic layer may be a sintered body of ferrite, magnetic powder or the like, which does not contain an organic resin.

The coil 15 includes a first inductor wire 21 and a second inductor wire 22. Each of the first inductor wire 21 and the second inductor wire 22 is wound along a plane orthogonal to the first direction D1 between the first magnetic layer 11 and the second magnetic layer 12. Specifically, the first magnetic layer 11 is present in the second direction D2 with respect to the first inductor wire 21 and the second inductor wire 22, and the second magnetic layer 12 is present in the first direction D1 and in the direction orthogonal to the first direction D1 with respect to the first inductor wire 21 and the second inductor wire 22.

The first inductor wire 21 is a wire that is wound along the plane orthogonal to the first direction D1 and extends in a spiral shape. It is preferable that the number of turns of the first inductor wire 21 exceeds 1 turn. Thus, the inductance value can be improved. “Exceeds 1 turn” refers to a state in which, in a section orthogonal to the axis of the inductor wire, the inductor wire has portions that are adjacent in a radial direction and run parallel in a winding direction as viewed from a direction of the axis, and “1 turn or less” refers to a state in which, in a section orthogonal to the axis, the inductor wire does not have the portions that are adjacent in the radial direction and run parallel in the winding direction as viewed from the direction of the axis. According to this embodiment, the number of turns of the first inductor wire 21 is 2 turns. The first inductor wire 21 is spirally wound in a clockwise direction from an inner peripheral end 21a toward an outer peripheral end 21b when viewed from the Z direction.

The second inductor wire 22 is a wire that is disposed on the second direction D2 side with respect to the first inductor wire 21, is wound along the plane orthogonal to the first direction D1, and extends in a spiral shape. The second inductor wire 22 is electrically connected to the first inductor wire 21. It is preferable that the number of turns of the second inductor wire 22 exceeds 1 turn. Thus, the inductance value can be improved. According to this embodiment, the number of turns of the second inductor wire 22 is 2.5 turns. The second inductor wire 22 is spirally wound in a clockwise direction from an outer peripheral end 22b toward an inner peripheral end 22a when viewed from the Z direction. The second inductor wire 22 is disposed between the first inductor wire 21 and the first magnetic layer 11. Thus, each of the first inductor wire 21 and the second inductor wire 22 is disposed in the first direction D1.

The outer peripheral end 21b of the first inductor wire 21 is connected to the second external electrode 42 with the second extended wire 52, which is in contact with the top surface of the outer peripheral end 21b, interposed therebetween. The outer peripheral end 22b of the second inductor wire 22 is connected to the first external electrode 41 with the first extended wire 51, which is in contact with the top surface of the outer peripheral end 22b, interposed therebetween. The inner peripheral end 22a of the second inductor wire 22 is connected to the inner peripheral end 21a of the first inductor wire 21 with a via wire 25, which is in contact with the top surface of the inner peripheral end 22a, interposed therebetween. With the above configuration, the first inductor wire 21 and the second inductor wire 22 are connected in series and are electrically connected to the first external electrode 41 and the second external electrode 42.

Each of the first inductor wire 21 and the second inductor wire 22 is made of a conductive material and includes a seed layer S and a plating layer P which is formed with a part being in contact with the seed layer S.

Specifically, as shown in FIG. 2, the seed layer S is disposed substantially at the center of the wire width in the X direction of each of the first and second inductor wires 21, 22. The seed layer S is provided in a manner of being exposed from a part of bottom surfaces 213, 223 of the first and second inductor wires 21, 22. The seed layer S is formed in a shape corresponding to the shapes of the first and second inductor wires 21,22 when viewed from the Z direction. That is, the seed layer S linearly extends in a spiral shape when viewed from the Z direction. The wire width of the seed layer S is smaller than the wire width of each of the first and second inductor wires 21, 22. The seed layer S is, for example, a laminate of Cu and Ti.

The wire width of the seed layer S may be set to be the same as the wire width of each of the first and second inductor wires 21, 22. When the wire width of the seed layer S is made smaller than the wire width of the first inductor wire 21 as in this embodiment, it is possible to prevent a part of the insulation layer 60 from getting over the seed layer S when forming a part of the insulation layer 60 existing between adjacent turns of the first inductor wire 21 after forming the seed layer S. When a part of the insulation layer 60 gets over the seed layer S, a short circuit may occur between adjacent turns.

The plating layer P covers the seed layer S in the first direction D1 and a direction orthogonal to the first direction D1. Thus, the plating layer P is formed with a part being in contact with the seed layer S. The plating layer P is made of, for example, a metal material having a low electrical resistance such as Cu, Ag, Au, or Al.

According to this embodiment, a semi-additive method using the seed layer S is used as a method of forming the first and second inductor wires 21, 22, however, a known method such as a subtractive method, a full additive method, a damascene method, a dual damascene method, or a printing method using a conductive paste may also be used.

The first extended wire 51 is made of a conductive material, extends in the first direction D1 from the top surface of the second inductor wire 22, and penetrates the insides of the insulation layer 60 and the second magnetic layer 12. The first extended wire 51 includes a via wire 25 that is provided on the top surface of the outer peripheral end 22b of the second inductor wire 22 and penetrates the inside of the insulation layer 60, a first columnar wire 31 that extends from the top surface of the via wire 25 in the first direction D1 and penetrates the inside of the second magnetic layer 12, another via wire 25 that is provided on the top surface of the first columnar wire 31 and penetrates the inside of the insulation layer 60, and a second columnar wire 32 that extends from the top surface of the another via wire 25 in the first direction D1, penetrates the inside of the second magnetic layer 12, and has an end surface exposed on the first principal surface 10a of the element body 10. The via wire is a conductor having a wire width (diameter and sectional area) smaller than that of the columnar wire.

The second extended wire 52 is made of a conductive material, extends in the first direction D1 from the top surface of the first inductor wire 21, and penetrates the inside of the second magnetic layer 12. The second extended wire 52 includes a via wire 25 which is provided on the top surface of the outer peripheral end 21b of the first inductor wire 21 and penetrates the inside of the insulation layer 60, and a third columnar wire 33 which extends in the first direction D1 from the top surface of the via wire 25, penetrates the inside of the second magnetic layer 12, and has an end surface exposed on the first principal surface 10a of the element body 10. It is preferable that the first and second extended wires 51, 52 are made of the same material as the plating layer P of the first and second inductor wires 21, 22.

The first and second external electrodes 41, 42 are provided on the first principal surface 10a of the element body 10. The first and second external electrodes 41, 42 are made of a conductive material, and have a three-layer configuration in which, for example, Cu having low electrical resistance and excellent stress resistance, Ni having excellent corrosion resistance, and Au having excellent solder wettability and reliability are arranged in this order from the inside to the outside.

The first external electrode 41 is in contact with the end surface of the first extended wire 51 exposed from the first principal surface 10a of the element body 10 and is electrically connected to the first extended wire 51. Thus, the first external electrode 41 is electrically connected to the outer peripheral end 22b of the second inductor wire 22. The second external electrode 42 is in contact with the end surface of the second extended wire 52 exposed from the first principal surface 10a of the element body 10 and is electrically connected to the second extended wire 52. Thus, the second external electrode 42 is electrically connected to the outer peripheral end 21b of the first inductor wire 21. In FIG. 1, the first and second external electrodes 41, 42 are indicated by two-dot chain lines for convenience.

The insulation layer 60 is made of an insulating material containing no magnetic body. The insulation layer 60 is, for example, an organic resin such as an epoxy resin, a phenol resin, a polyimide resin, a liquid crystal polymer, or a combination thereof, a sintered body such as glass or alumina, a thin film such as a silicon oxide film, a silicon nitride film, or a silicon oxynitride film, or the like.

At least a part of the inner peripheral surface 211 of the innermost periphery of the first inductor wire 21 is in contact with the second magnetic layer 12 without being covered with the insulation layer 60. The innermost periphery of the inductor wire refers to the inner periphery on the radially inner side of the inductor wire when the inductor wire has 1 turn or less, and refers to the inner periphery on the radially inner side of a portion of the inductor wire that constitutes 1 turn including the inner peripheral end when the inductor wire has more than 1 turn. According to this embodiment, the entire inner peripheral surface 211 of the innermost periphery of the first inductor wire 21 is in contact with the second magnetic layer 12 without being covered with the insulation layer 60.

A portion of the outer surface of the first inductor wire 21 and the outer surface of the second inductor wire 22 excluding the inner peripheral surface 211 of the innermost periphery of the first inductor wire 21 is in contact with the insulation layer 60. Thus, it is possible to ensure the insulating properties between the first inductor wire 21, the second inductor wire 22 and the first magnetic layer 11, the second magnetic layer 12.

Specifically, the insulation layer 60 is in contact with and covers the entire top surface 212 of the first inductor wire 21 facing the first direction D1 side, the entire bottom surface 213 of the first inductor wire 21 facing the second direction D2 side, the entire outer peripheral surface 214 of the outermost periphery of the first inductor wire 21, the entire inner peripheral surface 221 of the innermost periphery of the second inductor wire 22, the entire top surface 222 of the second inductor wire 22 facing the first direction D1 side, the entire bottom surface 223 of the second inductor wire 22 facing the second direction D2 side, and the entire outer peripheral surface 224 of the outermost periphery of the second inductor wire 22. The outermost periphery of the inductor wire refers to the outer periphery on the radially outer side of the inductor wire when the inductor wire has 1 turn or less, and refers to the outer periphery on the radially outer side of a portion of the inductor wire that constitutes 1 turn including the outer peripheral end when the inductor wire has more than 1 turn.

Furthermore, the insulation layer 60 is also provided between adjacent turns of the first inductor wire 21 and between adjacent turns of the second inductor wire 22. Thus, in each of the first inductor wire 21 and the second inductor wire 22, a short circuit between adjacent turns can be suppressed.

The covering layer 50 is, for example, a solder resist containing an epoxy resin as a main component. It is preferable that the covering layer 50 is provided in a region of the first principal surface 10a of the element body 10 where the first external electrode 41 and the second external electrode 42 are not provided. By providing the covering layer 50, the inductor component 1 can be protected from the external environment.

According to the inductor component 1, at least a part of the inner peripheral surface 211 of the innermost periphery of the first inductor wire 21 is in contact with the second magnetic layer 12 without being covered with the insulation layer 60, and thus, the volume of the second magnetic layer 12 can be increased as compared with the case where the entire outer surface of the first inductor wire 21 is covered with the insulation layer 60. As a result, the inductance value of the inductor component 1 can be improved.

Magnetic fluxes are particularly likely to concentrate in the inner magnetic path portion of the coil 15. In the inductor component 1, at least a part of the inner peripheral surface 211 of the innermost periphery of the first inductor wire 21 is in contact with the second magnetic layer 12 without being covered with the insulation layer 60, and thus, the concentration of magnetic fluxes in the inner magnetic path portion of the coil 15 can be reduced. Thus, the inductance value can be more effectively improved than in the case where the portion of the outer surface of the first inductor wire 21 other than the inner peripheral surface 211 of the innermost periphery is in contact with the second magnetic layer 12 without being covered with the insulation layer 60.

Preferably, the coil 15 further includes the second inductor wire 22 wound along a plane orthogonal to the first direction D1, wherein the second inductor wire 22 is disposed closer to the side of the second direction D2 opposite to the first direction D1 than the first inductor wire 21 and is electrically connected to the first inductor wire 21, and the insulation layer 60 is present at least between the first inductor wire 21 and the second inductor wire 22 and covers the inner peripheral surface 221 of the innermost periphery of the second inductor wire 22.

According to the above-described configuration, the second inductor wire 22 is further included, and thus, the inductance value can be further improved. In addition, since the insulation layer 60 is present at least between the first inductor wire 21 and the second inductor wire 22, the insulating properties between the first inductor wire 21 and the second inductor wire 22 can be ensured. In addition, since the insulation layer 60 covers the inner peripheral surface 221 of the innermost periphery of the second inductor wire 22, the insulating properties between the inner peripheral surface 211 of the innermost periphery of the first inductor wire 21 and the inner peripheral surface 221 of the innermost periphery of the second inductor wire 22 can be ensured.

It is preferable to further provide the second extended wire 52 that is connected to an end portion (outer peripheral end 21b) in the extension direction of the first inductor wire 21, extends in the first direction D1, and is exposed from the outer surface of the element body 10. According to this configuration, it is possible to connect the first inductor wire 21 and an external circuit or the like at the shortest distance through the second extended wire 52 without providing an unnecessary routing wire. Similarly, it is preferable to further provide the first extended wire 51 that is connected to an end portion (outer peripheral end 22b) in the extension direction of the second inductor wire 22, extends in the first direction D1, and is exposed from the outer surface of the element body 10. According to this configuration, it is possible to connect the first inductor wire 21 and an external circuit or the like at the shortest distance through the first extended wire 51 without providing an unnecessary routing wire.

(Modification)

FIG. 3 is a schematic sectional view illustrating an inductor component 1A according to a modification. FIG. 3 corresponds to the II-II section (FIG. 2) of FIG. 1. In FIG. 3, for convenience, the illustration of the side of the second side surface of the element body is omitted.

As shown in FIG. 3, the thickness t1 in the first direction D1 of the second magnetic layer 12 which is present between the first principal surface 10a of the element body 10 and the first inductor wire 21 is smaller than the thickness t2 in the first direction D1 of the first magnetic layer 11 which is present between the second principal surface 10b of the element body 10 and the second inductor wire 22.

According to the above-described configuration, the thickness t1 in the first direction D1 of the second magnetic layer 12 which is present between the first principal surface 10a of the element body 10 and the first inductor wire 21 is relatively small, and thus, the length in the first direction D1 of the second columnar wire 32 penetrating the second magnetic layer 12 can be shortened. As a result, the length in the first direction D1 of the first extended wire 51 can also be shortened, and thus, the first extended wire 51 can be easily formed. When the thickness t1 is relatively large, there is a possibility that plating growth is insufficient when the second columnar wire 32 is formed by electrolytic plating, for example. In addition, according to the above-described configuration, the length in the first direction D1 of the first extended wire 51 can be shortened, and thus, the electrical resistance of the first extended wire 51 can be reduced. Similarly, according to the above-described configuration, the length in the first direction D1 of the second extended wire which is not illustrated can be shortened, and thus, the second extended wire can be easily formed. In addition, the electrical resistance of the second extended wire can be reduced.

When the thickness t1 is relatively small, magnetic fluxes are more likely to concentrate between the first principal surface 10a of the element body 10 and the first inductor wire 21 as compared with the case when the thicknesses t1 is relatively large. In the inductor component 1A, the inner peripheral surface 211 of the innermost periphery of the first inductor wire 21 is not covered with the insulation layer 60, whereas the inner peripheral surface 221 of the innermost periphery of the second inductor wire 22 is covered with the insulation layer 60. Thus, by selectively only not covering the inner peripheral surface 211 of the innermost periphery of the first inductor wire 21 with the insulation layer 60, when the thickness t1 is relatively small, the concentration of magnetic fluxes between the first principal surface 10a of the element body 10 and the first inductor wire 21 can also be mitigated, and the insulating properties between the inner peripheral surface 211 of the innermost periphery of the first inductor wire 21 and the inner peripheral surface 221 of the innermost periphery of the second inductor wire 22 can also be ensured.

(Manufacturing Method)

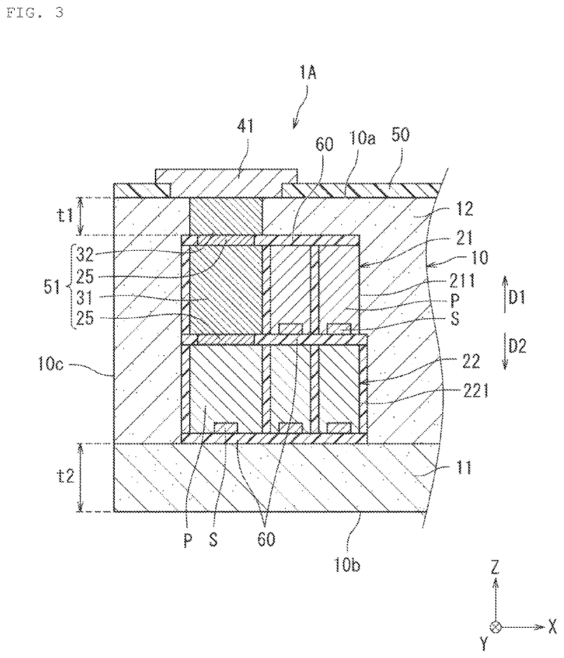

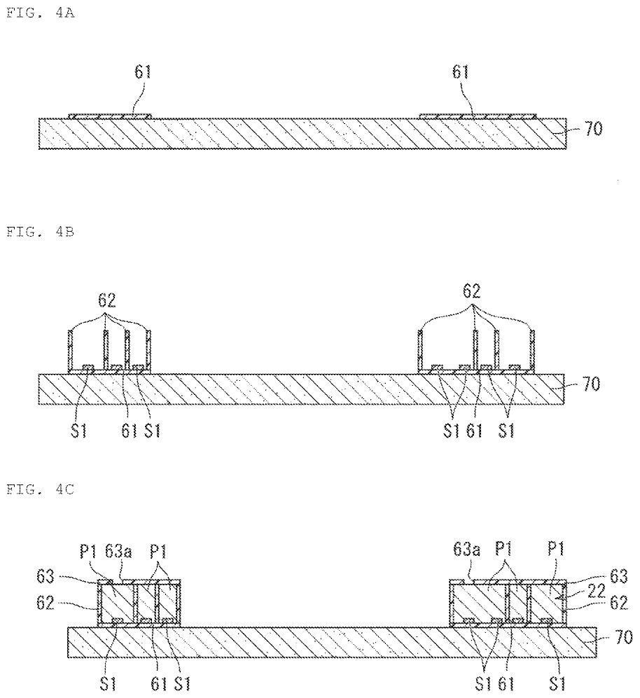

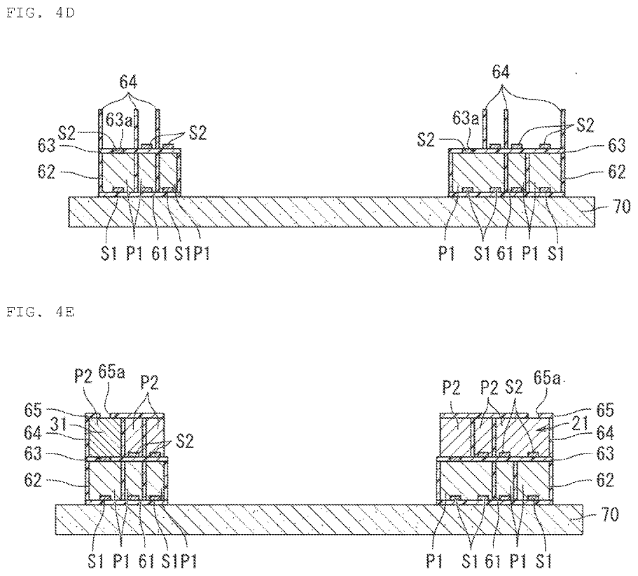

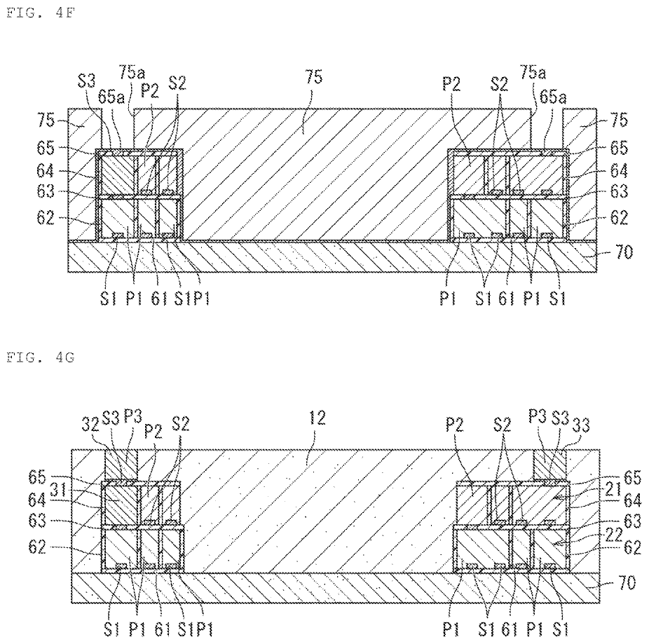

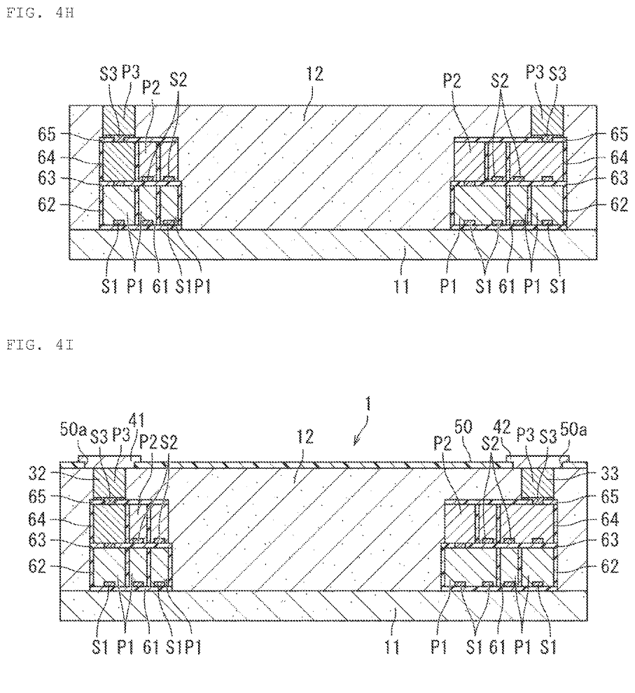

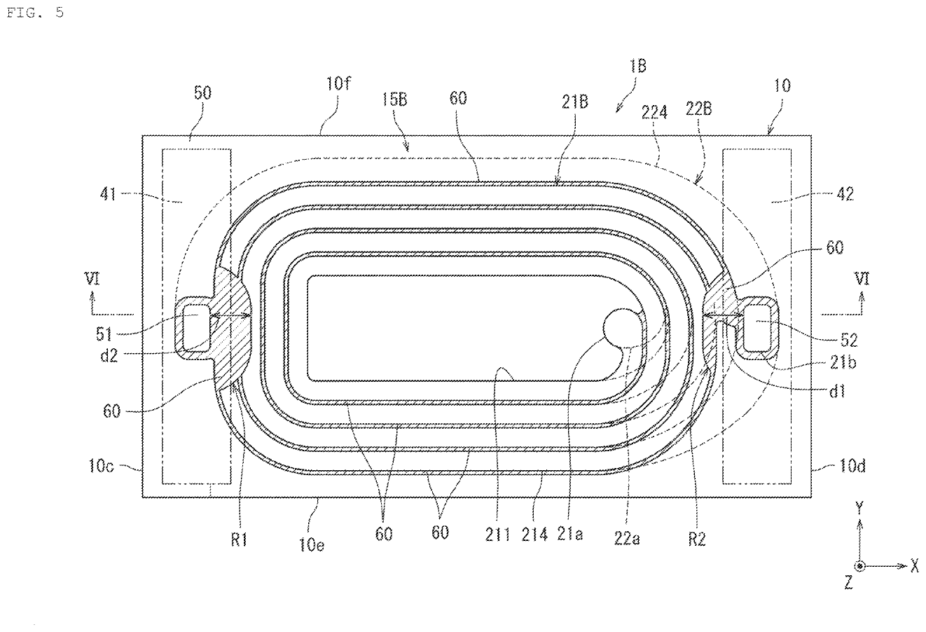

Next, an example of a method for manufacturing the inductor component 1 will be described. FIGS. 4A to 41 are explanatory diagrams illustrating a manufacturing method of the inductor component 1. FIGS. 4A to 41 correspond to the II-II section (FIG. 2) of FIG. 1.

As illustrated in FIG. 4A, a support substrate 70 is prepared. The support substrate 70 is made of, for example, an inorganic material such as ceramic, epoxy glass, or glass. An insulating resin is applied onto the principal surface of the support substrate 70, exposed and developed using a photolithography method, and the insulating resin is patterned. The patterning shape is such that the insulating resin covers at least the bottom surface of the second inductor wire 22 to be formed in a later step. Thereafter, the insulating resin is cured to form a first insulating resin layer 61 which is to be a part of the insulation layer 60. As the insulating resin, an epoxy resin, a polyimide resin, or the like may be used.

As shown in FIG. 4B, the first seed layer 51 is formed in a manner of covering the first insulating resin layer 61 using a sputtering method or the like. Thereafter, a resist which is not illustrated is applied, and then the first seed layer 51 is patterned using the photolithography method. The patterning shape is a shape corresponding to the spiral shape of the second inductor wire 22 to be formed in a later step. Thereafter, an insulating resin film is laminated in a manner of covering the first insulating resin layer 61 and the first seed layer 51. Thereafter, the insulating resin film is exposed and developed using the photolithography method to pattern the insulating resin film. The patterning shape is such that the insulating resin film is provided on the inner peripheral surface of the innermost periphery of the second inductor wire 22, between adjacent turns of the second inductor wire 22, and on the outer peripheral surface of the outermost periphery of the second inductor wire 22, wherein the inner peripheral surface, adjacent turns and outer peripheral surface are formed in a later step. Thereafter, the insulating resin film is cured to form a second insulating resin layer 62 which is to be a part of the insulation layer 60. As the insulating resin film, an epoxy resin film, a polyimide resin film, or the like may be used.

As shown in FIG. 4C, a first plating layer P1 is formed by electrolytic plating while power is supplied to the first seed layer S1. Thus, the first plating layer P1 is formed with a part being in contact with the first seed layer S1, and the second inductor wire 22 is formed. Thereafter, the insulating resin film is laminated in a manner of covering the first insulating resin layer 61, the second insulating resin layer 62, and the second inductor wire 22. Thereafter, the insulating resin film is exposed and developed using the photolithography method to pattern the insulating resin film. The patterning shape is such that the insulating resin film covers the top surface of the second inductor wire 22. An opening 63a is formed in the insulating resin film at a position where the via wire 25 connected to the top surface of the second inductor wire 22 is provided. Thereafter, the insulating resin film is cured to form a third insulating resin layer 63 which is to be a part of the insulation layer 60.

As shown in FIG. 4D, a second seed layer S2 is formed in a manner of covering the first to third insulating resin layers 61 to 63 and the opening 63a using the sputtering method or the like. Thereafter, a resist which is not illustrated is applied, and then the second seed layer S2 is patterned using the photolithography method. The patterning shape is a shape corresponding to the spiral shape of the first inductor wire 21 to be formed in a later step. At this time, the second seed layer S2 is also formed in the opening 63a. The second seed layer S2 formed in the opening 63a becomes the via wire 25 connected to the top surface of the second inductor wire 22. Thereafter, the insulating resin film is laminated in a manner of covering the first to third insulating resin layers 61 to 63 and the second seed layer S2. Thereafter, the insulating resin film is exposed and developed using the photolithography method to pattern the insulating resin film. The patterning shape is such that the insulating resin film is provided between adjacent turns of the first inductor wire 21, and on the outer peripheral surface of the outermost periphery of the first inductor wire 21, which is formed in a later step. At this time, the insulating resin film is not provided on the inner peripheral surface of the innermost periphery of the first inductor wire 21. Thereafter, the insulating resin film is cured to form a fourth insulating resin layer 64 which is to be a part of the insulation layer 60.

As shown in FIG. 4E, a second plating layer P2 is formed by electrolytic plating while power is supplied to the second seed layer S2. Thus, the second plating layer P2 is formed with a part being in contact with the second seed layer S2, and the first inductor wire 21 and the first columnar wire 31 are formed. Thereafter, the insulating resin film is laminated in a manner of covering the first to fourth insulating resin layers 61 to 64, the first columnar wire 31, and the first inductor wire 21. Thereafter, the insulating resin film is exposed and developed using the photolithography method to pattern the insulating resin film. The patterning shape is such that the insulating resin film covers the top surface of the first columnar wire 31 and the top surface of the first inductor wire 21. An opening 65a is formed in the insulating resin film at a position where the via wire 25 connected to the top surface of the first inductor wire 21 and the top surface of the first columnar wire 31 is provided. Thereafter, the insulating resin film is cured to form a fifth insulating resin layer 65 which is to be a part of the insulation layer 60.

As shown in FIG. 4F, the third seed layer S3 is formed using the sputtering method or the like in a manner of covering the first to fifth insulating resin layers 61 to 65 and the opening 65a. The third seed layer S3 formed in the opening 65a becomes the via wire 25 connected to the top surface of the first inductor wire 21 and the top surface of the first columnar wire 31. Thereafter, a resist 75 is applied, exposed and developed using the photolithography method, and an opening 75a is formed at a predetermined position of the resist 75. The predetermined position is a position where the second columnar wire 32 and the third columnar wire 33 are provided.

As shown in FIG. 4G, a third plating layer P3 is formed in the opening 75a of the resist 75 by electrolytic plating while power is supplied to the third seed layer S3. Thus, the second columnar wire 32 and the third columnar wire 33 are formed. Thereafter, the resist 75 is removed, and a portion of the third seed layer S3 other than the portion provided on the bottom surface of the second columnar wire 32 and the bottom surface of the third columnar wire 33 is etched using the photolithography method. Thereafter, the magnetic sheet to be the second magnetic layer 12 is pressure-bonded from above the principal surface of the support substrate 70 toward the first inductor wire 21 and the second inductor wire 22, and the first inductor wire 21, the second inductor wire 22, the first to fifth insulating resin layers 61 to 65, and the first to third columnar wires 31 to 33 are covered with the second magnetic layer 12. Thereafter, the top surface of the second magnetic layer 12 is ground, and the end surfaces of the second columnar wire 32 and the third columnar wire 33 are exposed from the top surface of the second magnetic layer 12.

As shown in FIG. 4H, the support substrate 70 is removed, and another magnetic sheet to be the first magnetic layer 11 is pressure-bonded from below the second inductor wire 22 toward the first inductor wire 21 and the second inductor wire 22 to cover the bottom surface of the first insulating resin layer 61 with the first magnetic layer 11. Thereafter, the first magnetic layer 11 is ground to a predetermined thickness.

As shown in FIG. 4I, an insulating resin film to be the covering layer 50 is laminated on the top surface of the second magnetic layer 12. Thereafter, the insulating resin film is exposed and developed using the photolithography method to pattern the insulating resin film. The patterning shape is such that the covering layer 50 covers a region of the top surface of the second magnetic layer 12 excluding a region where the first and second external electrodes 41, 42 are formed. Thereafter, the insulating resin film is cured to form the covering layer 50. Thereafter, the first external electrode 41 and the second external electrode 42 are formed by, for example, electroless plating in a manner of covering the end surface of the second columnar wire 32 and the end surface of the third columnar wire 33 exposed from the top surface of the second magnetic layer 12. In this way, the inductor component 1 is manufactured.

### Second Embodiment

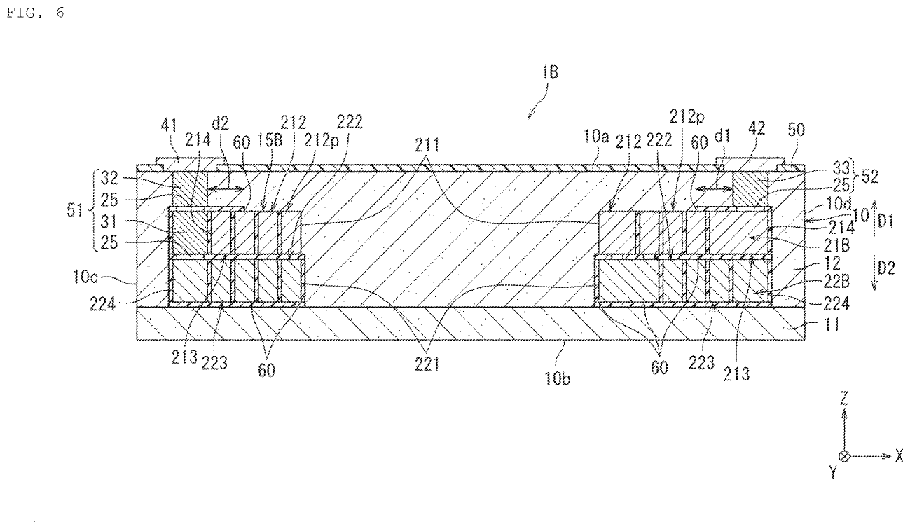

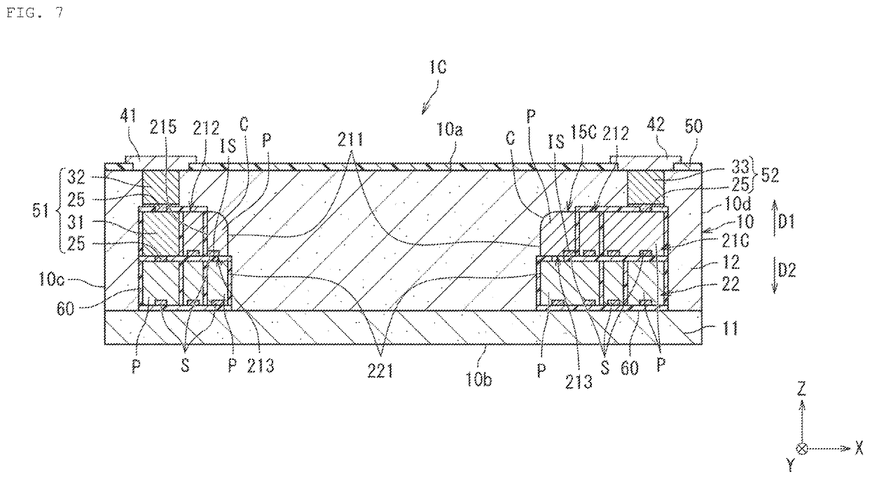

FIG. 5 is a schematic plan view illustrating a second embodiment of the inductor component. FIG. 6 is a sectional view taken along VI-VI of FIG. 5. In FIG. 5, for convenience, the positions where an insulation layer is present are shaded. In FIG. 6, for convenience, the description of the seed layer is omitted. The second embodiment is different from the first embodiment in the number of turns of the first and second inductor wires and in that the insulation layer does not cover a part of the top surface of the first inductor wire. This different configuration will be described below. The other configurations are the same as those of the first embodiment, and are denoted by the same reference signs as those of the first embodiment, and the description thereof will be omitted.

As shown in FIG. 5 and FIG. 6, according to this embodiment, the number of turns of the first inductor wire 21B is 4 turns. The number of turns of the second inductor wire 22B is 4.5 turns. Thus, the inductance value can be further improved.

At least a part of the top surface 212 of the first inductor wire 21B is in contact with the second magnetic layer 12 without being covered with the insulation layer 60, and a portion 212p, which is in contact with the second magnetic layer 12, of the top surface 212 of the first inductor wire 21 is continuous with the inner peripheral surface 211 of the innermost periphery of the first inductor wire 21.

Specifically, when viewed from the Z direction, the insulation layer 60 is provided on a portion of the top surface 212 of the first inductor wire 21B that is present in a predetermined region R1 around the first extended wire 51 and a portion of the top surface 212 of the first inductor wire 21B that is present in a predetermined region R2 around the second extended wire 52. On the other hand, when viewed from the Z direction, the insulation layer 60 is not provided in any portion of the top surface 212 of the first inductor wire 21B other than the predetermined region R1 around the first extended wire 51 and any portion of the top surface 212 of the first inductor wire 21B other than the predetermined region R2 around the second extended wire 52, and is in contact with the second magnetic layer 12. The shape of the predetermined region R1 is not particularly limited, and according to this embodiment, the predetermined region R1 has a substantially fan shape around the first extended wire 51 when viewed from the Z direction. Similarly, the shape of the predetermined region R2 is not particularly limited, and according to this embodiment, the predetermined region R2 has a substantially fan shape around the second extended wire 52 when viewed from the Z direction.

According to the above-described configuration, the volume of the second magnetic layer 12 can be further increased, and thus, the inductance value can be further improved. As described above, when the thickness in the first direction D1 of the second magnetic layer 12 which is present between the first principal surface 10a of the element body 10 and the first inductor wire 21B is relatively small, magnetic fluxes are more likely to concentrate between the first principal surface 10a of the element body 10 and the first inductor wire 21B as compared with the case when the thickness is relatively large. According to the inductor component 1B, at least a part of the top surface 212 of the first inductor wire 21B is in contact with the second magnetic layer 12 without being covered with the insulation layer 60, and thus, when the above-described thickness is relatively small, the concentration of magnetic fluxes between the first principal surface 10a of the element body 10 and the first inductor wire 21B can also be mitigated.

It is preferable to further provide the second extended wire 52 which is connected to an end portion (outer peripheral end 21b) in the extension direction of the first inductor wire 21, extends in the first direction D1 and is exposed from the outer surface of the element body 10, wherein a distance d1 between the portion 212p, which is in contact with the second magnetic layer 12, of the top surface 212 of the first inductor wire 21B and the second extended wire 52 is 80 μm or more. The distance d1 between the portion 212p which is in contact with the second magnetic layer 12 and the second extended wire 52 refers to the shortest distance between the portion 212p, which is in contact with the second magnetic layer 12, and the outer periphery of the second extended wire 52 when viewed from the Z direction.

According to the above-described configuration, it is possible to suppress the occurrence of short-circuit between the portion 212p, which is in contact with the second magnetic layer 12, and the second extended wire 52. Specifically, when a potential difference is generated in the conductive portion of the inductor component 1B due to ESD (Electro Static Discharge) or the like, there is a possibility that a short-circuit occurs through the magnetic powder of the first and second magnetic layers 11, 12. In particular, the distance between the first and second extended wires 51, 52 and the first and second inductor wires 21B, 22B that are present around the first and second extended wires 51, 52 is relatively short, and thus, a short circuit is likely to occur. The present inventors have found that when a part of the top surface 212 of the first inductor wire 21B is in contact with the second magnetic layer 12 without being covered with the insulation layer 60, the short-circuit risk can also be reduced to the same extent as in the case where the entire top surface 212 of the first inductor wire 21B is covered with the insulation layer 60 if the distance d1 is 80 μm or more.

It is preferable to further provide the first extended wire 51 which is connected to an end portion (outer peripheral end 22b) in the extension direction of the second inductor wire 22, extends in the first direction D1 and is exposed from the outer surface of the element body 10, wherein a distance d2 between the portion 212p, which is in contact with the second magnetic layer 12, of the top surface 212 of the first inductor wire 21 and the first extended wire 51 is 80 μm or more. The distance d2 between the portion 212p which is in contact with the second magnetic layer 12 and the first extended wire 51 refers to the shortest distance between the portion 212p, which is in contact with the second magnetic layer 12, and the outer periphery of the first extended wire 51 when viewed from the Z direction. According to this configuration, it is possible to suppress the occurrence of short-circuit between the portion 212p, which is in contact with the second magnetic layer 12, and the first extended wire 51.

As a method of manufacturing the inductor component 1B, for example, according to the manufacturing method described with reference to FIGS. 4A to 41, the first seed layer 51 and the second seed layer S2 may be configured to have 4 turns and 4.5 turns when they are patterned, respectively, corresponding to the number of turns of the first and second inductor wires, and the fifth insulating resin layer 65 may be formed only in the predetermined region R1 and the predetermined region R2 when the insulating resin film of the fifth insulating resin layer 65 is patterned.

### Third Embodiment

FIG. 7 is a schematic sectional view illustrating a third embodiment of the inductor component. FIG. 7 corresponds to the II-II section (FIG. 2) of FIG. 1. The third embodiment is different from the first embodiment in the shape of the first inductor wire and the position where the seed layer of the first inductor wire is provided, and in that the insulation layer does not cover a part of the top surface of the first inductor wire. This different configuration will be described below. The other configurations are the same as those of the first embodiment, and are denoted by the same reference signs as those of the first embodiment, and the description thereof will be omitted.

As shown in FIG. 7, a part of the top surface 212 of the first inductor wire 21C is in contact with the second magnetic layer 12 without being covered with the insulation layer 60. Specifically, the top surface 212 of the first inductor wire 21C of the portion including the innermost periphery is in contact with the second magnetic layer 12 without being covered with the insulation layer 60. Thus, compared to the case where the entire top surface 212 of the first inductor wire 21C is covered with the insulation layer 60, the volume of the second magnetic layer 12 can be further increased, and the inductance value can be further improved.

In the section that is orthogonal to the extension direction of the first inductor wire 21 and intersects the portion, which is in contact with the second magnetic layer 12, of the inner peripheral surface 211 of the innermost periphery of the first inductor wire 21, a seed layer IS which is present in the portion including the innermost periphery of the first inductor wire 21C is disposed to be biased to the side opposite to the side of the inner peripheral surface 211 of the innermost periphery of the first inductor wire 21 with respect to the center of the first inductor wire 21 in the direction (X direction) orthogonal to the first direction D1. The portion including the innermost periphery of the first inductor wire 21C refers to a portion constituting 1 turn of the first inductor wire 21C including the inner peripheral end 21a of the first inductor wire 21C. When the number of turns of the first inductor wire 21C exceeds 1 turn as in this embodiment, the section may be orthogonal to the extension direction of the portion including the innermost periphery of the first inductor wire 21C and may intersect the portion, which is in contact with the second magnetic layer 12, of the inner peripheral surface 211 of the innermost periphery of the first inductor wire 21.

According to the above-described configuration, when at least a part of the inner peripheral surface of the innermost periphery of the first inductor wire 21C is not covered with the insulation layer 60, the height of the first direction D1 of the plating layer P in the portion including the innermost periphery of the first inductor wire 21C can also be ensured, and the spread of the plating layer P in the direction orthogonal to the first direction D1 can also be suppressed.

Preferably, the first inductor wire 21C has the bottom surface 213 facing the side of the second direction D2 opposite to the first direction D1, and the seed layer IS which is present in the portion including the innermost periphery of the first inductor wire 21C is provided at a corner portion between an outer peripheral surface 215 opposite to the inner peripheral surface 211 of the innermost periphery of the first inductor wire 21C and the bottom surface 213 of the first inductor wire 21C. According to this configuration, the height in the first direction D1 of the plating layer P in the portion including the innermost periphery of the first inductor wire 21C can be more reliably ensured, and the spread of the plating layer P in the direction orthogonal to the first direction D1 can be further suppressed.

Preferably, the first inductor wire 21C has the top surface 212 facing the side of the first direction D1, and a portion including the innermost periphery of the first inductor wire 21C has a curved surface C at a corner portion between the inner peripheral surface 211 of the innermost periphery of the first inductor wire 21C and the top surface 212 of the first inductor wire 21C. The shape of the curved surface C is not particularly limited, and is a convex curved surface that is convex toward the outside of the first inductor wire 21C according to this embodiment.

According to the above-described configuration, it is possible to increase the distance in the facing direction between the wire or the like facing the inner peripheral surface 211 of the innermost periphery of the first inductor wire 21C and the portion including the innermost periphery of the first inductor wire 21C, as compared with the case where the corner portion has a shape in which planes intersect each other. Thus, it is possible to suppress the occurrence of short-circuit between the wire or the like and the first inductor wire 21C. In addition, since the corner portion has the curved surface C, it is possible to suppress the disturbance of magnetic fluxes caused by the corner portion.

As a method of manufacturing the inductor component 1C, for example, according to the manufacturing method described with reference to FIGS. 4A to 41, when the second seed layer S2 is patterned, a seed layer which is present in the portion including the innermost periphery of the first inductor wire may be disposed to be biased to the side opposite to the side of the inner peripheral surface of the innermost periphery of the first inductor wire with respect to the center of the first inductor wire in the direction orthogonal to the first direction D1 in the section that is orthogonal to the extension direction of the first inductor wire and intersects the portion, which is in contact with the second magnetic layer, of the inner peripheral surface of the innermost periphery of the first inductor wire.

Note that the present disclosure is not limited to the above-described embodiments, and can be modified in design without departing from the gist of the present disclosure. For example, the characteristic features of the first to third embodiments may be combined in various ways.

Although the first and second extended wires, the first and second external electrodes, and the covering layer are provided according to the above-described first to third embodiments, these members are not essential and may not be provided or may be replaced with other members.

Although the inductor wire has two layers according to the above-described first to third embodiments, the inductor wire may have one layer, or may have three or more layers.

According to the first to third embodiments, the entire inner peripheral surface of the innermost periphery of the first inductor wire is in contact with the second magnetic layer without being covered with the insulation layer, but a part of the inner peripheral surface of the innermost periphery of the first inductor wire may be in contact with the second magnetic layer without being covered with the insulation layer and other portions of the inner peripheral surface may be covered with the insulation layer. According to the first to third embodiments, the entire inner peripheral surface of the innermost periphery of the second inductor wire is covered with the insulation layer, but at least a part of the inner peripheral surface of the innermost periphery of the second inductor wire may be in contact with the second magnetic layer without being covered with the insulation layer. Thus, the volume of the magnetic layer is further increased, and the inductance value can be further improved.

According to the first to third embodiments, the entire outer peripheral surface of the outermost periphery of each of the first and second inductor wires is covered with the insulation layer, but at least a part of the outer peripheral surface of the outermost periphery of each of the first and second inductor wires may be in contact with the second magnetic layer without being covered with the insulation layer. Thus, the volume of the magnetic layer is further increased, and the inductance value can be further improved.

According to the first to third embodiments, the entire bottom surface of the second inductor wire is covered with the insulation layer, but at least a part of the bottom surface of the second inductor wire may be in contact with the first magnetic layer without being covered with the insulation layer. Thus, the volume of the magnetic layer is further increased, and the inductance value can be further improved.

According to the second embodiment and the third embodiment, a part of the top surface of the first inductor wire is covered with the insulation layer and other portions of the top surface are in contact with the second magnetic layer without being covered with the insulation layer, but the entire top surface of the first inductor wire may be in contact with the second magnetic layer without being covered with the insulation layer. Thus, the volume of the magnetic layer is further increased, and the inductance value can be further improved.
<1> An inductor component including an element body that includes a magnetic layer and has a first principal surface and a second principal surface opposite to each other; a coil that is disposed in the element body; and an insulation layer that covers a part of an outer surface of the coil. The coil having a first inductor wire wound along a plane orthogonal to a first direction which is orthogonal to the first principal surface and is from the second principal surface toward the first principal surface. At least a part of an inner peripheral surface of an innermost periphery of the first inductor wire being in contact with the magnetic layer without being covered with the insulation layer.
<2> The inductor component according to <1>, wherein the coil further includes a second inductor wire wound along a plane orthogonal to the first direction. Also, the second inductor wire is disposed on a side of a second direction opposite to the first direction with respect to the first inductor wire and is electrically connected to the first inductor wire, and the insulation layer is present at least between the first inductor wire and the second inductor wire and covers an inner peripheral surface of an innermost periphery of the second inductor wire.
<3> The inductor component according to <2>, further including an extended wire that is connected to an end portion in an extension direction of the first inductor wire, extends in the first direction, and is exposed from an outer surface of the element body.
<4> The inductor component according to <3>, wherein a thickness in the first direction of the magnetic layer, which is present between the first principal surface of the element body and the first inductor wire, is smaller than a thickness in the first direction of the magnetic layer, which is present between the second principal surface of the element body and the second inductor wire.
<5> The inductor component according to any one of <1> to <4>, wherein the first inductor wire has a top surface facing a side of the first direction. At least a part of the top surface of the first inductor wire is in contact with the magnetic layer without being covered with the insulation layer. Also, a portion, which is in contact with the magnetic layer, of the top surface of the first inductor wire is continuous with the inner peripheral surface of the innermost periphery of the first inductor wire.
<6> The inductor component according to <5>, further including an extended wire that is connected to an end portion in an extension direction of the first inductor wire, extends in the first direction, and is exposed from an outer surface of the element body. A distance between the extended wire and the portion, which is in contact with the magnetic layer, of the top surface of the first inductor wire is 80 μm or more.
<7> The inductor component according to any one of <1> to <6>, wherein the first inductor wire has a seed layer and a plating layer formed with a part being in contact with the seed layer. The seed layer which is present in a portion of the first inductor wire including the innermost periphery is disposed to be biased to a side opposite to a side of the inner peripheral surface of the innermost periphery of the first inductor wire with respect to a center of the first inductor wire in a direction orthogonal to the first direction in a section that is orthogonal to an extension direction of the first inductor wire and intersects a portion, which is in contact with the magnetic layer, of the inner peripheral surface of the innermost periphery of the first inductor wire.
<8> The inductor component according to <7>, wherein the first inductor wire has a bottom surface facing a side of a second direction opposite to the first direction. Also, the seed layer which is present in a portion of the first inductor wire including the innermost periphery is provided at a corner portion between an outer peripheral surface opposite to the inner peripheral surface of the innermost periphery of the first inductor wire and the bottom surface of the first inductor wire.
<9> The inductor component according to <7> or <8>, wherein the first inductor wire has a top surface facing a side of the first direction. Also, a portion of the first inductor wire including the innermost periphery has a curved surface at a corner portion between the inner peripheral surface of the innermost periphery of the first inductor wire and the top surface of the first inductor wire.

What is claimed is:

1. An inductor component comprising:
an element body which includes a magnetic layer and includes a first principal surface and a second principal surface opposite to each other;
a coil which is in the element body; and
an insulation layer which covers a part of an outer surface of the coil,
the coil including a first inductor wire wound along a plane orthogonal to a first direction which is orthogonal to the first principal surface and is from the second principal surface toward the first principal surface, and
at least a part of an inner peripheral surface of an innermost periphery of the first inductor wire being in contact with the magnetic layer.

2. The inductor component according to claim 1, wherein
the coil further comprises a second inductor wire wound along a plane orthogonal to the first direction,
the second inductor wire is on a side of a second direction opposite to the first direction with respect to the first inductor wire and is electrically connected to the first inductor wire, and
the insulation layer is at least between the first inductor wire and the second inductor wire and covers an inner peripheral surface of an innermost periphery of the second inductor wire.

3. The inductor component according to claim 2, further comprising:
an extended wire which is connected to an end portion of the first inductor wire in an extension direction of the first inductor wire,
wherein the extended wire extends in the first direction, and is exposed from an outer surface of the element body.

4. The inductor component according to claim 3, wherein
a thickness of the magnetic layer in the first direction, which is between the first principal surface of the element body and the first inductor wire, is smaller than a thickness of the magnetic layer in the first direction, which is between the second principal surface of the element body and the second inductor wire.

5. The inductor component according to claim 1, wherein
the first inductor wire includes a top surface facing a side of the first direction,
at least a part of the top surface of the first inductor wire is in contact with the magnetic layer, and
a portion of the top surface of the first inductor wire, the portion being in contact with the magnetic layer, is continuous with the inner peripheral surface of the innermost periphery of the first inductor wire.

6. The inductor component according to claim 5, further comprising:
an extended wire which is connected to an end portion of the first inductor wire in an extension direction of the first inductor wire, such that the extended wire extends in the first direction and is exposed from an outer surface of the element body,
wherein a distance between the extended wire and the portion of the top surface of the first inductor wire, which is in contact with the magnetic layer, is 80 μm or more.

7. The inductor component according to claim 1, wherein
the first inductor wire includes a seed layer and a plating layer which is partially in contact with the seed layer, and
the seed layer, which is in a portion of the first inductor wire including the innermost periphery, is shifted to a side opposite to a side of the inner peripheral surface of the innermost periphery of the first inductor wire with respect to a center of the first inductor wire in a direction orthogonal to the first direction, in a cross section which is orthogonal to an extension direction of the first inductor wire and intersects a portion, which is in contact with the magnetic layer, of the inner peripheral surface of the innermost periphery of the first inductor wire.

8. The inductor component according to claim 7, wherein
the first inductor wire includes a bottom surface facing a side of a second direction opposite to the first direction, and
the seed layer which is in a portion of the first inductor wire including the innermost periphery is at a corner portion between an outer peripheral surface opposite to the inner peripheral surface of the innermost periphery of the first inductor wire and the bottom surface of the first inductor wire.

9. The inductor component according to claim 7, wherein
the first inductor wire includes a top surface facing a side of the first direction, and
a portion of the first inductor wire including the innermost periphery has a curved surface at a corner portion between the inner peripheral surface of the innermost periphery of the first inductor wire and the top surface of the first inductor wire.

10. The inductor component according to claim 2, wherein
the first inductor wire includes a top surface facing a side of the first direction,
at least a part of the top surface of the first inductor wire is in contact with the magnetic layer, and
a portion of the top surface of the first inductor wire, the portion being in contact with the magnetic layer, is continuous with the inner peripheral surface of the innermost periphery of the first inductor wire.

11. The inductor component according to claim 3, wherein
the first inductor wire includes a top surface facing a side of the first direction,
at least a part of the top surface of the first inductor wire is in contact with the magnetic layer, and
a portion of the top surface of the first inductor wire, the portion being in contact with the magnetic layer, is continuous with the inner peripheral surface of the innermost periphery of the first inductor wire.

12. The inductor component according to claim 4, wherein
the first inductor wire includes a top surface facing a side of the first direction,
at least a part of the top surface of the first inductor wire is in contact with the magnetic layer, and
a portion of the top surface of the first inductor wire, the portion being in contact with the magnetic layer, is continuous with the inner peripheral surface of the innermost periphery of the first inductor wire.

13. The inductor component according to claim 10, further comprising:
an extended wire which is connected to an end portion of the first inductor wire in an extension direction of the first inductor wire, such that the extended wire extends in the first direction and is exposed from an outer surface of the element body,
wherein a distance between the extended wire and the portion of the top surface of the first inductor wire, which is in contact with the magnetic layer, is 80 μm or more.

14. The inductor component according to claim 11, further comprising:
an extended wire which is connected to an end portion of the first inductor wire in an extension direction of the first inductor wire, such that the extended wire extends in the first direction and is exposed from an outer surface of the element body,
wherein a distance between the extended wire and the portion of the top surface of the first inductor wire, which is in contact with the magnetic layer, is 80 μm or more.

15. The inductor component according to claim 12, further comprising:
an extended wire which is connected to an end portion of the first inductor wire in an extension direction of the first inductor wire, such that the extended wire extends in the first direction and is exposed from an outer surface of the element body,
wherein a distance between the extended wire and the portion of the top surface of the first inductor wire, which is in contact with the magnetic layer, is 80 μm or more.

16. The inductor component according to claim 2, wherein
the first inductor wire includes a seed layer and a plating layer which is partially in contact with the seed layer, and
the seed layer, which is in a portion of the first inductor wire including the innermost periphery, is shifted to a side opposite to a side of the inner peripheral surface of the innermost periphery of the first inductor wire with respect to a center of the first inductor wire in a direction orthogonal to the first direction, in a cross section which is orthogonal to an extension direction of the first inductor wire and intersects a portion, which is in contact with the magnetic layer, of the inner peripheral surface of the innermost periphery of the first inductor wire.

17. The inductor component according to claim 3, wherein
the first inductor wire includes a seed layer and a plating layer which is partially in contact with the seed layer, and
the seed layer, which is in a portion of the first inductor wire including the innermost periphery, is shifted to a side opposite to a side of the inner peripheral surface of the innermost periphery of the first inductor wire with respect to a center of the first inductor wire in a direction orthogonal to the first direction, in a cross section which is orthogonal to an extension direction of the first inductor wire and intersects a portion, which is in contact with the magnetic layer, of the inner peripheral surface of the innermost periphery of the first inductor wire.

18. The inductor component according to claim 4, wherein
the first inductor wire includes a seed layer and a plating layer which is partially in contact with the seed layer, and
the seed layer, which is in a portion of the first inductor wire including the innermost periphery, is shifted to a side opposite to a side of the inner peripheral surface of the innermost periphery of the first inductor wire with respect to a center of the first inductor wire in a direction orthogonal to the first direction, in a cross section which is orthogonal to an extension direction of the first inductor wire and intersects a portion, which is in contact with the magnetic layer, of the inner peripheral surface of the innermost periphery of the first inductor wire.

19. The inductor component according to claim 16, wherein
the first inductor wire includes a bottom surface facing a side of a second direction opposite to the first direction, and
the seed layer which is in a portion of the first inductor wire including the innermost periphery is at a corner portion between an outer peripheral surface opposite to the inner peripheral surface of the innermost periphery of the first inductor wire and the bottom surface of the first inductor wire.

20. The inductor component according to claim 16, wherein
the first inductor wire includes a top surface facing a side of the first direction, and
a portion of the first inductor wire including the innermost periphery has a curved surface at a corner portion between the inner peripheral surface of the innermost periphery of the first inductor wire and the top surface of the first inductor wire.
